(19) United States
(12) Patent Application Publication
(10) Pub. No.: US 2004/0092274 A1
(43) Pub. Date: May 13, 2004

(54) Radio communication system, a radio station suitably used for the same

(75) Inventors: Sung Uk Moon, Yokosuka-shi (JP); Takehiro Nakamura, Yokosuka-shi (JP); Minami Ishii, Yokohama-shi (JP); Masafumi Usuda, Yokosuka-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc, Tokyo (JP)

(21) Appl. No.: 10/699,820

(22) Filed: Nov. 4, 2003

(30) Foreign Application Priority Data
Nov. 5, 2002 (JP) 2002-321836

(51) Int. Cl. H04Q 7/20; H04B 7/00; H04M 1/00; H04B 1/38

(52) U.S. Cl. 455/500; 455/524; 455/560; 455/561; 455/424

(57) ABSTRACT

The object of the present invention is to make the most of reception abilities and radio resources of mobile stations 41 to 43, by determining transmission methods of transmitting information based on the reception abilities of the mobile stations 41 to 43 when the base station 40 performs multicast communication. The radio communication system according to the present invention has a reception ability value collector 42b, a transmission method determiner 42c, a transmitter 42a and a radio resource manager 42e. The reception ability value collector 42b collects a reception ability value of mobile stations 41 to 43 belonging to a multicast group A. The transmission method determiner determines a transmission method of transmitting information in accordance with the collected reception ability value. The transmitter 42a transmits the information to the mobile station 41 to 43 using the determined transmission method. The radio resource manager 42e manages available radio resources. The transmission method determiner determines the transmission method in accordance with the reception ability and the available radio resources, so that a mobile station 41 equipped with a predetermined reception ability can receive the information using the determined transmission method.

### CROSS REFERENCE TO RELATED APPLICATION

This application is based upon and claims the benefit of priority from the prior Japanese Patent Application No. P2002-321836, filed on Nov. 5, 2003; the entire contents of which are incorporated herein by reference.

### BACKGROUND OF THE INVENTION

1. Field of the Invention

The present invention relates to a radio communication system whereby one or a plurality of base stations transmit common information to a plurality of mobile stations, a radio station (a base station or a radio network controller) suitably used for the same.

2. Description of the Related Art

As shown in FIG. 1, broadcast communication whereby a plurality of base stations 11 to 17 transmit common information to unspecified mobile stations 101 to 112 in predetermined areas is known in a conventional radio communication system.

As shown in FIG. 2, multicast communication whereby a plurality of base stations 11 to 17 transmit common information to specific mobile stations joining in (belonging to) a specific group is known in a conventional radio communication system.

A method of transmitting and receiving information which is organized hierarchically by a modulation method and so on, and a method of organizing information hierarchically by transmission power, the numbers of codes, importance and so on, in the above radio communication system.

However, there is a problem in that a mobile station which is not equipped with a specific reception ability cannot receive information which requires a specific reception ability to be received, when a plurality of mobile stations joining in a multicast group have various reception abilities, and when a base station transmits common information without consideration of reception abilities of the mobile stations.

There is a problem in that a mobile station cannot make the most of a highly developed reception ability upon receiving specific type of information.

### BRIEF SUMMARY OF THE INVENTION

In viewing of the foregoing, it is an object of the present invention to provide a radio communication system which can make the most of a reception ability and radio resources of a mobile station, by determining information to be transmitted in consideration of the reception ability of the mobile station, when a base station performs multicast communication.

A first aspect of the present invention is summarized as a radio communication system for performing multicast communication. The radio communication system comprises a reception ability value collector configured to collect a reception ability value of a mobile station belonging to a specific multicast group; a transmission method determiner configured to determine a transmission method of transmitting information in accordance with the collected reception ability value; a transmitter configured to transmit the information to the mobile station using the determined transmission method; and a radio resource manager configured to manage available radio resources. The transmission method determiner determines the transmission method in accordance with the reception ability value and the available radio resources, so that a mobile station equipped with a predetermined reception ability can receive the information using the determined transmission method.

A second aspect of the present invention is summarized as a radio station such as a base station and a radio network controller. The radio station comprises a reception ability value collector configured to collect a reception ability value of a mobile station belonging to a specific multicast group; a transmission method determiner configured to determine a transmission method of transmitting information in accordance with the collected reception ability value; and a transmitter configured to transmit the information to the mobile station using the determined transmission method. The transmission method determiner determines the transmission method so that a mobile station equipped with the best reception ability can receive the information using the determined transmission method.

A third aspect of the present invention is summarized as a radio station such as a base station and a radio network controller. The radio station comprises a reception ability value collector configured to collect a reception ability value of a mobile station belonging to a specific multicast group; a transmission method determiner configured to determine a transmission method of transmitting information in accordance with the collected reception ability value; and a transmitter configured to transmit the information to the mobile station using the determined transmission method. The transmission method determiner determines the transmission method so that a mobile station equipped with the worst reception ability can receive the information using the determined transmission method.

A fourth aspect of the present invention is summarized as a radio station such as a base station and a radio network controller. The radio station comprises a reception ability value collector configured to collect a reception ability value of a mobile station belonging to a specific multicast group; a transmission method determiner configured to determine a transmission method of transmitting information in accordance with the collected reception ability value; a transmitter configured to transmit the information to the mobile station using the determined transmission method; and a radio resource manager configured to manage available radio resources. The transmission method determiner determines the transmission method in accordance with the reception ability value and the available radio resources, so that a mobile station equipped with a predetermined reception ability can receive the information using the determined transmission method.

In the second to fourth aspects, the reception ability value may be defined by at least one of a demodulation method, a reception buffer size, a computing processing ability, an error correction method and an interleaving length.

In the second to fourth aspects, the transmission method may be determined by at least one of a modulation method, transmission power, a method of organizing the information hierarchically, the amount of data, the numbers of codes, an error correction method, the numbers of blocks, an interleaving length and a rate matching method.

In the second to fourth aspects, the radio resource may be defined by at least one of transmission power, the numbers of codes, the numbers of frequencies and propagation conditions.

### BRIEF DESCRIPTION OF THE SEVERAL VIEWS OF THE DRAWINGS

FIG. 1 is a diagram for explaining broadcast communication according to the prior art.

FIG. 2 is a diagram for explaining multicast communication according to the prior art.

FIG. 3 is a diagram showing the entire configuration of a radio communication system according to embodiments of the present invention.

FIG. 4 is a functional block diagram of a radio station suitably used for the radio communication system according to the first embodiment.

FIG. 5 is a flow chart illustrating the operation of the radio station suitably used for the radio communication system according to a first embodiment.

FIG. 6 is a functional block diagram of a radio station suitably used for the radio communication system according to a second embodiment.

FIG. 7 is a flow chart illustrating the operation of the radio station suitably used for the radio communication system according to the second embodiment.

FIG. 8 is a functional block diagram of a radio station suitably used for the radio communication system according to a third embodiment.

FIG. 9 is a flow chart illustrating the operation of the radio station suitably used for the radio communication system according to the third embodiment.

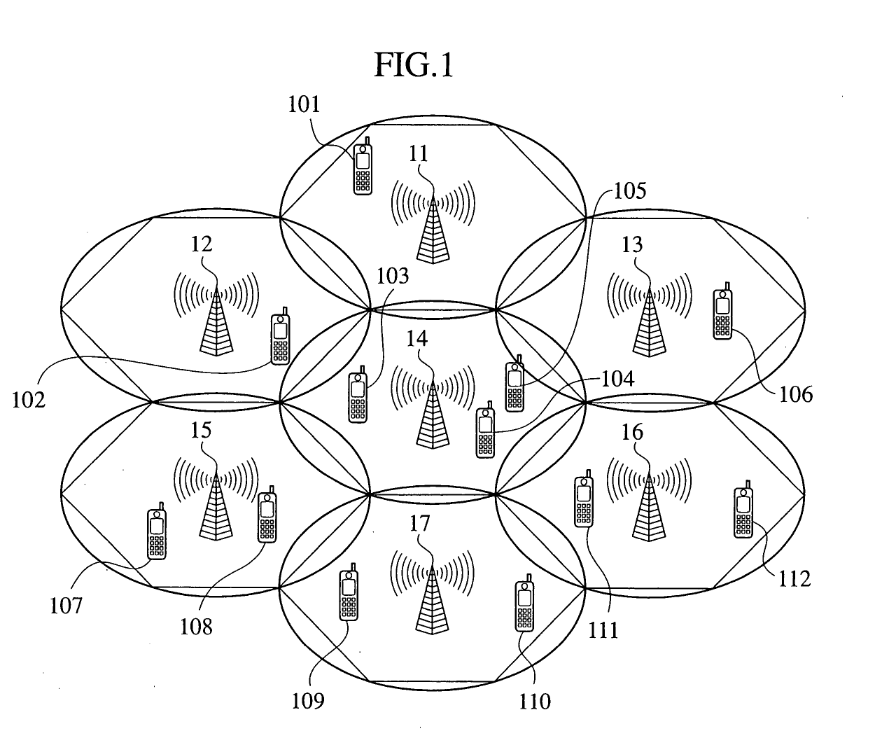

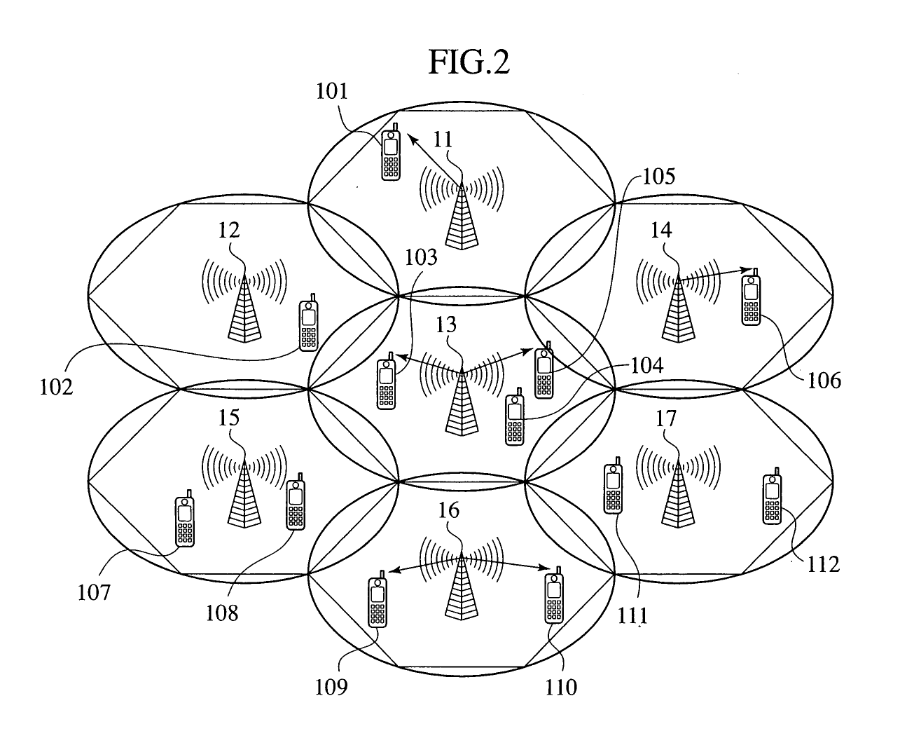

### DETAILED DESCRIPTION OF THE INVENTION

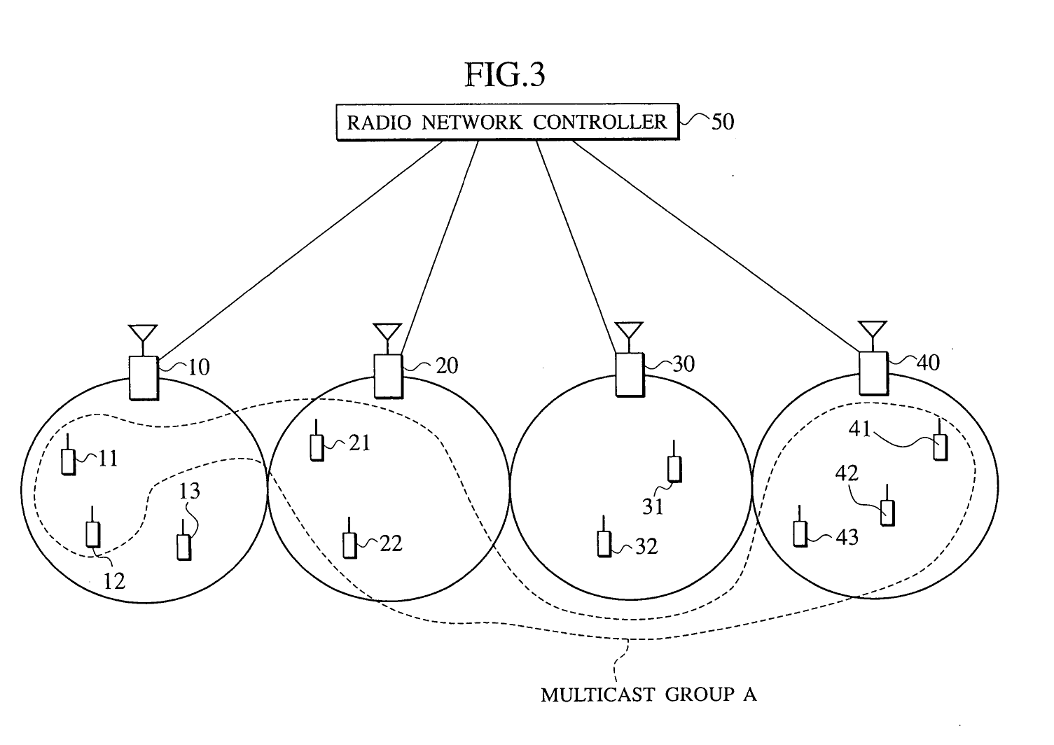

FIG. 3 shows the entire configuration of a radio communication system according to embodiments of the present invention.

As shown in FIG. 3, the radio communication system according to the first embodiment comprises four base stations 10, 20, 30 and 40 under a radio network controller 50.

In the radio communication system according to the embodiments, the base station 10 manages mobile stations 11 to 13, the base station 20 manages mobile stations 21 and 22, the base station 30 manages mobile stations 31 and 32, and the base station 40 manages mobile stations 41 to 43. The mobile stations 11, 12, 21,41, 42 and 43 join in (belong to) a multicast group A in the embodiment.

In the embodiments, functions of a radio station are installed in a radio network controller 50 or a plurality of base stations 10 to 30.

<A Configuration of a Radio Communication System According to a First Embodiment of the Present Invention>

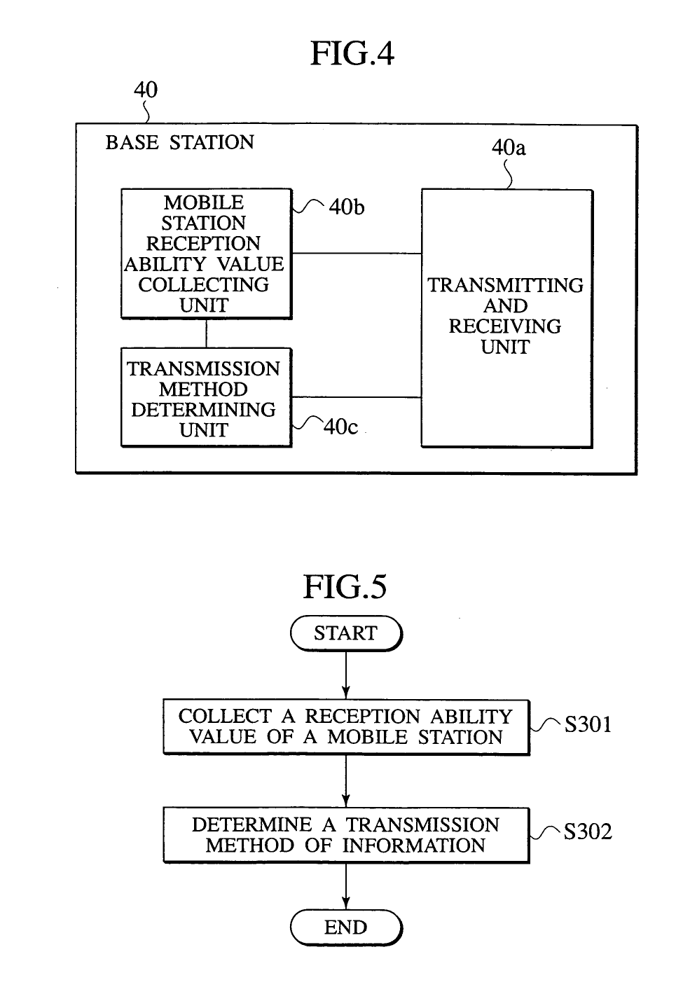

FIG. 4 shows functional blocks of a base station installed with the functions of the radio station suitably used for the radio communication system according to the first embodiment. Functions of a plurality of base stations 10 to 40 are basically the same, so that the functions of the base station 40 will be explained as follows.

As shown in FIG. 4, the base station 40 is configured with a transmitting and receiving unit 40a, a mobile station reception ability value collecting unit 40b and a transmission method determining unit 40c.

The transmitting and receiving unit 40a is configured to receive signals transmitted from the mobile stations 41 to 43, and signals transmitted from other radio stations (for example, the radio network controller 50 and base stations 10 to 30).

The transmitting and receiving unit 40a is configured to transmit information to the mobile stations 41, 42 and 43 joining in the multicast group A, using a determined transmission method determined by the transmission method determining unit 40c.

The transmitting and receiving unit 40a transmits predetermined information to other radio stations (for example, the radio network controller 50 and base stations 10 to 30).

The mobile station reception ability value collecting unit 40b is configured to collect a reception ability value of each of the mobile stations 41, 42 and 43 joining in the multicast group A, based on signals received by the transmitting and receiving unit 40a.

For example, the mobile station reception ability value collecting unit 40b collects “Class 1” as a reception ability value of the mobile station 41, “Class 2” as a reception ability value of the mobile station 42 and “Class 3” as a reception ability value of the mobile station 43.

The transmission method determining unit 40c is configured to determine a transmission method of transmitting information to be transmitted to the mobile station, in accordance with the collected reception ability value “Class 1”, “Class 2” or “Class 3”.

To be more specific, the transmission method determining unit 40c determines the transmission method, so that a mobile station equipped with a predetermined reception ability of “Class 1”, “Class 2” or “Class 3” can receive the information using the determined transmission method.

The reception ability value of the mobile station is defined by at least one of a demodulation method which the mobile station can use, a reception buffer size of the mobile station, a computing processing ability of the mobile station, an error correction method which the mobile station uses, an interleaving length which the mobile station uses and so on.

The computing processing ability is defined by the numbers of bits or codes which a processor of the mobile station can process per one operation, a computing method, a computing speed and so on.

The demodulation method considered as the reception ability includes the QPSK (Quadrature Phase Shift Keying), the 8PSK, the 16QAM (Quadrature Amplitude Modulation), 64QAM and so on.

For example, the reception ability of the mobile station 41 can demodulate signals modulated with the QPSK, the 8PSK and the 16QAM, the reception ability of the mobile station 42 can demodulate signals modulated with the QPSK and the 8PSK, the reception ability of the mobile station 43 can demodulate signals modulated with the only QPSK, in the first embodiment.

In this case, the only mobile station 41 can demodulate information which the transmitting and receiving unit 40a of the base station 40 modulated and transmitted with the 16QAM. On the other hand, the mobile stations 41, 42 and 43 can demodulate information which the transmitting and receiving unit 40a of the base station 40 modulated and transmitted with the QPSK.

An example whereby the reception buffer size (memory size) is adopted as the reception ability value will be described as follows.

For example, it is assumed that the reception buffer size of the mobile station 41 is “10M bytes”, the reception buffer size of the mobile station 42 is “5M bytes”, and the reception buffer size of the mobile station 43 is “1M bytes”.

In this case, the mobile stations 41, 42 and 43 cannot receive more than 10M bytes of information transmitted by the transmitting and receiving unit 40a of the base station 40.

An example whereby the computing processing ability is adopted as the reception ability value will be described as follows.

In this case, when the transmitting and receiving unit 40a of the base station 40 transmits information to the mobile station which cannot process more than 1M bytes per one operation, using a transmission method requiring more than 1M bytes of computing processing per one operation.

In this case, when the transmitting and receiving unit 40a of the base station 40 transmits information multiplied with 4 codes to the mobile station 41 which can process a maximum of 10 codes per one operation, the mobile station 42 which can process a maximum of 5 codes per one operation, the mobile station 43 which can process a maximum of 3 codes per one operation, the mobile station 43 cannot perform a reception processing of the information.

In this case, when the transmitting and receiving unit 40a of the base station 40 transmits information to the mobile station which does not support a computing method as a RAKE receiving function, using a transmission method requiring the computing method as a RAKE receiving function, the mobile station cannot perform a reception processing of the information.

In this case, when the transmitting and receiving unit 40a of the base station 40 transmits information to the mobile station, using a transmission method imposing a load more than an computing speed at which a mobile station can process, the mobile station cannot perform a reception processing of the information.

An example whereby the error correction method is adopted as the reception ability value will be described as follows. The error correction method considered as the reception ability includes the collapse codes, the Turbo codes and so on.

In this case, when the transmitting and receiving unit 40a of the base station 40 transmits information to the mobile station which does not support the collapse codes, using the error correction method with the collapse codes, the mobile station cannot perform an error correction processing.

An example whereby the interleaving length is adopted as the reception ability value will be described as follows. For example, it is assumed that a mobile station can be configured to deinterleave information interleaved with 320 ms, 160 ms, 80 ms or 10 ms.

In this case, when the transmitting and receiving unit 40a of the base station 40 transmits information interleaved with 320 ms to the mobile station which does not support a interleaving length of 320 ms, the mobile station cannot perform deinterleave the information.

The transmission method determining unit 40c can adopt a combination of a plurality of items such as the demodulation method, the reception buffer size, the computing processing ability, the error correction method and the interleaving length.

The transmission method is determined by at least one of a modulation method, transmission power, a method of organizing the information hierarchically, the amount of data, the numbers of codes, an error correction method, the numbers of blocks, an interleaving length and a rate matching method and so on.

The method of organizing the information hierarchically means a method of transmitting and receiving the information organized hierarchically by a modulation method, transmission power, the numbers of codes, the numbers of blocks, importance and so on.

The transmission method determining unit 40c can adopt a combination of a plurality of items such as a modulation method, transmission power, a method of organizing the information hierarchically, the amount of data, the numbers of codes, an error correction method, the numbers of blocks, an interleaving length and a rate matching method.

<An Operation of the Radio Communication System According to the First Embodiment>

Referring to FIG. 5, the operation of the radio communication system according to the first embodiment will be described.

As shown in FIG. 5, in step 301, the mobile station reception ability value collecting unit 40b collects the reception ability values of the mobile stations 41, 42 and 43 joining in the multicast group A in accordance with the signal received by the transmitting and receiving unit 40a.

In step 302, the transmission method determining unit 40c determines the transmission method of transmitting information to the mobile stations 41, 42 and 43, in accordance with the collected reception ability values. Then the transmitting and receiving unit 40a transmits the information to the mobile stations 41, 42 and 43 using the determined transmission method.

<A Configuration of a Radio Communication System According to a Second Embodiment of the Present Invention>

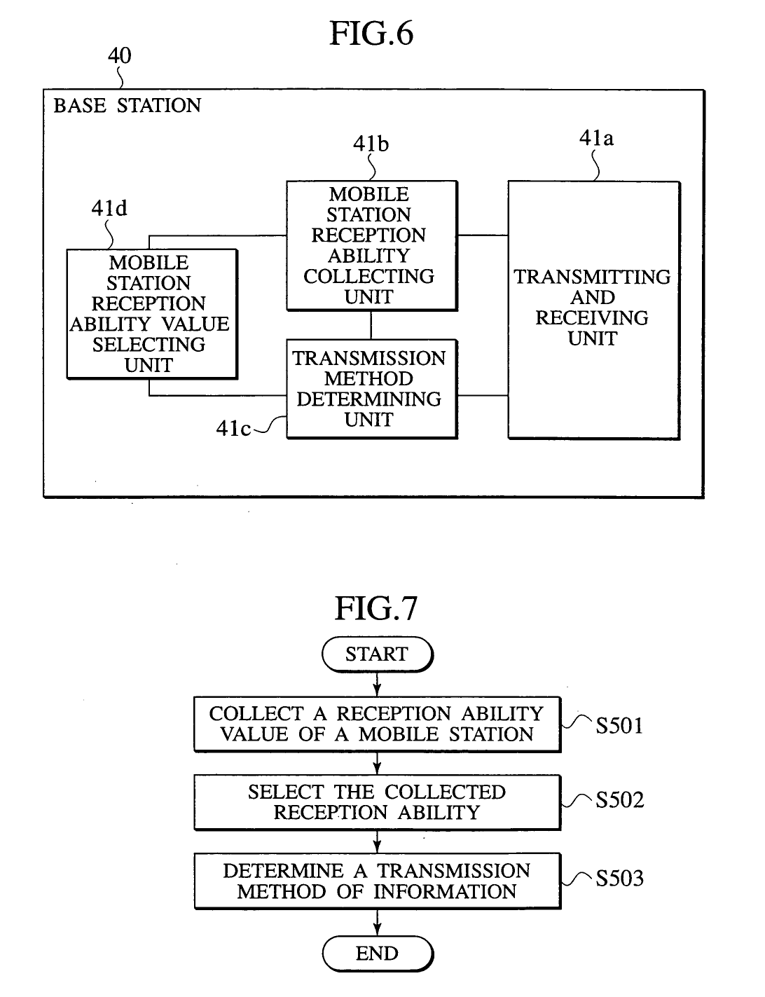

FIG. 6 shows functional blocks of a base station installed with the functions of the radio station suitably used for the radio communication system according to the second embodiment. Functions of a plurality of base stations 10 to 40 are basically the same, so that the functions of the base station 40 will be explained as follows.

The base station 40 according to the second embodiment is configured with a mobile station reception ability selecting unit 41d, in addition to the functions of the base station according to the first embodiment. A transmitting and receiving unit 41a, a mobile station reception ability value collecting unit 41b and a transmission method determining unit 41c have same functions as the transmitting and receiving unit 40a, the mobile station reception ability value collecting unit 40b and the transmission method determining unit 40c in the radio communication system according to the first embodiment respectively.

The transmission method determining unit 41c is configured to determine a transmission method whereby the mobile station equipped with a reception ability selected by the mobile station reception ability selecting unit 41d can receive the information transmitted from the transmitting and receiving unit 41a.

The mobile station reception ability selecting unit 41d is configured to select the reception ability of the mobile station to which the information is transmitted, from among the reception abilities collected by the mobile station reception ability collecting unit 41b.

For example, when the reception ability of the mobile station 41 is “Class 1”, the reception ability of the mobile station 42 is “Class 2” and the reception ability of the mobile station 43 is “Class 3”, the mobile station reception ability selecting unit 41d can select all reception abilities, such as “Class 1”, “Class 2” and “Class 3”, with which the mobile stations can be equipped as the reception ability.

The mobile station reception ability selecting unit 41d can select a predetermined reception ability such as “Class 1” and “Class 2” as the reception ability of the mobile station to which the information is transmitted.

When “Class 1” means a more intelligent function than “Class 2” and “Class 2” means a more intelligent function than “Class 3”, themobile station reception ability selecting unit 41d can select the worst reception ability of “Class 3” as the reception ability of the mobile station to which the information is transmitted.

In this case, all mobile stations equipped with the reception ability of more than “Class 3” can receive the information.

The mobile station reception ability selecting unit 41d can select the best reception ability of “Class 1” as the reception ability of the mobile station to which the information is transmitted. In this case, mobile stations equipped with the reception ability of less than “Class 1” cannot receive the information.

<An Operation of the Radio Communication System According to the Second Embodiment>

Referring to FIG. 7, the operation of the radio communication system according to the second embodiment will be described.

As shown in FIG. 7, in step 501, the mobile station reception ability value collecting unit 41b collects the reception ability values of the mobile stations 41, 42 and 43 joining in the multicast group A in accordance with the signal received by the transmitting and receiving unit 41a.

In step 502, the mobile station reception ability selecting unit 42d selects the reception ability of the mobile station to which the information is transmitted, from among the collected reception ability values.

In step 503, the transmission method determining unit 41c determines the transmission method whereby the mobile station equipped with the reception ability selected by the mobile station reception ability selecting unit 41d can receive the information. Then the transmitting and receiving unit 41a transmit the information to the mobile station using the determined transmission method.

<A Configuration of a Radio Communication System According to a Third Embodiment of the Present Invention>

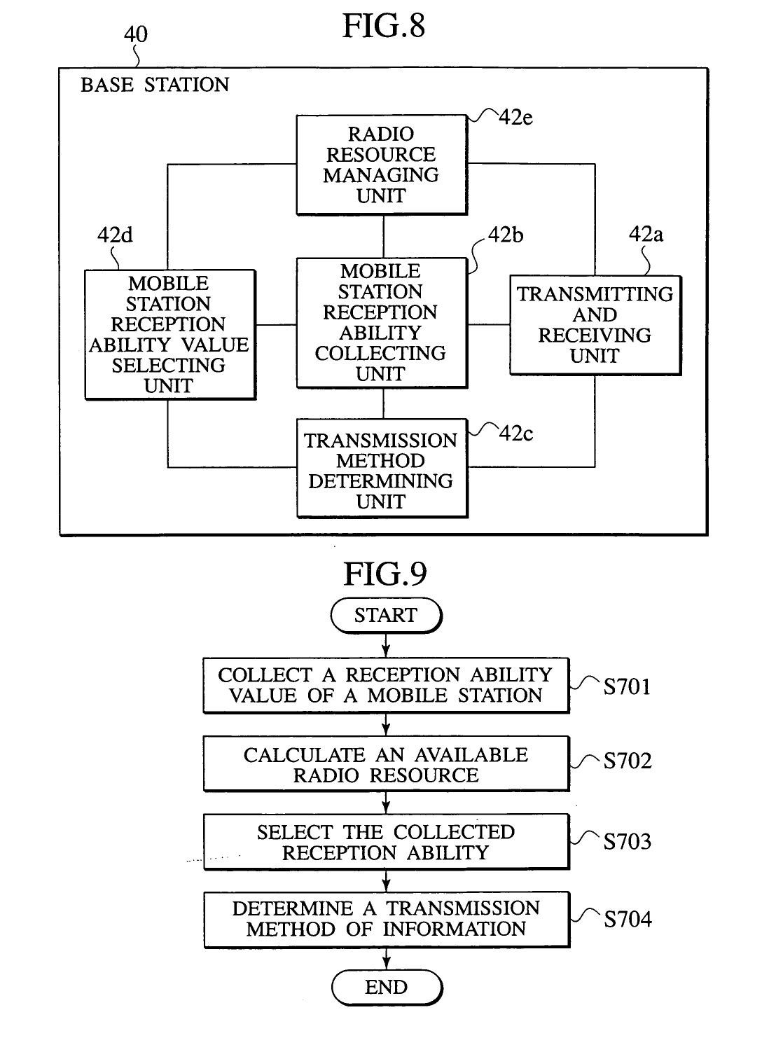

FIG. 8 shows functional blocks of a base station installed with the functions of the radio station suitably used for the radio communication system according to the third embodiment. Functions of a plurality of base stations 10 to 40 are basically the same, so that the functions of the base station 40 will be explained as follows.

The base station 40 according to the third embodiment is configured with a radio resource managing unit 42e, in addition to the functions of the base station according to the second embodiment. A transmitting and receiving unit 42a, a mobile station reception ability value collecting unit 42b, a transmission method determining unit 42c and a mobile station reception ability selecting unit 42d have same functions as the transmitting and receiving unit 41a, the mobile station reception ability value collecting unit 41b, the transmission method determining unit 41c and the mobile station reception ability selecting unit 41d in the radio communication system according to the second embodiment respectively.

The radio resource managing unit 42e is configured to manage available radio resources. To be more specific, the radio resource managing unit 42e manages all radio resources, radio resources in active use and available radio resources in the base station 40. The radio resource is defined by at least one of transmission power, the numbers of codes, the numbers of frequencies and propagation conditions and so on.

The transmission method determining unit 42c is configured to determine the transmission method, in accordance with the reception ability selected by the mobile station reception ability selecting unit 42d and the available radio resources.

To be more specific, the transmission method determining unit 42c compares the reception ability selected by the mobile station reception ability selecting unit 42d with the available radio resources managed by the radio resource managing unit 42e, and selects the transmission method based on the result of the comparison.

For example, when the amount of all radio resources is “100” and the amount of radio resources in active use is “50” in the base station 40, the amount of available radio resources is “50”.

For example, it is assumed that the transmission method T whereby the mobile station equipped with the reception ability of “Class 1” can receive the information requires the amount of radio resources whose value is “80”, the transmission method S whereby the mobile station equipped with the reception ability of “Class 2” can receive the information requires the amount of radio resources whose value is “40”, and the transmission method R whereby the mobile station equipped with the reception ability of “Class 3” can receive the information requires the amount of radio resources whose value is “20”.

In this case, the transmission method determining unit 42c cannot select the transmission method T, so as to select the transmission method R and S, in consideration of the available radio resources.

An example whereby the transmission power is adopted as the radio resource will be described as follows.

In this case, when the maximum of transmission power is 20W and the transmission power in active use is 10W in the base station 40, the available transmission power is low in the base station 40, so that the transmission method determining unit 42c cannot select the transmission method requiring the transmission power of more than 10W.

As in the case of the numbers of codes or frequencies being adopted as the radio resources, the transmission method determining unit 42c cannot select the transmission method requiring the codes or the frequencies more than the available codes or frequencies in the base station 40.

<An Operation of the Radio Communication System According to the Third Embodiment>

Referring to FIG. 9, the operation of the radio communication system according to the third embodiment will be described.

As shown in FIG. 9, in step 701, the mobile station reception ability value collecting unit 42b collects the reception ability values of the mobile stations 41, 42 and 43 joining in the multicast group A in accordance with the signal received by the transmitting and receiving unit 42a.

In step 702, the radio resource managing unit 42e calculates the available radio resources in the base station 40.

In step 703, the mobile station reception ability selecting unit 42d selects the reception ability of the mobile station to which the information is transmitted, from among the collected reception ability valuess.

In step 704, the transmission method determining unit 42c determines the transmission method whereby the mobile station equipped with the reception ability selected by the mobile station reception ability selecting unit 42d can receive the information, in accordance with the available radio resources calculated by the radio resource managing unit 42e. Then the transmitting and receiving unit 42a transmit the information to the mobile station using the determined transmission method.

<Functions and Effects of the Radio Communication System According to the Above Embodiments>

The radio communication system according to the above embodiments can make the most of reception abilities and radio resources of mobile stations 41 to 43, by determining transmission methods of transmitting information based on the reception abilities of the mobile stations 41 to 43 in the radio communication system whereby a base station 40 supporting broadcast communication and multicast communication transmits the information to the mobile stations 41 to 43.

The present invention can provide a radio communication system which can make the most of reception abilities and radio resources of mobile stations, by determining transmission methods of transmitting information based on the reception abilities of the mobile stations when the base station performs multicast communication, and a radio station which can be used in the above radio communication system.

Additional advantages and modifications will readily occur to those skilled in the art. Therefore, the invention in its broader aspects is not limited to the specific details and the representative embodiment shown and described herein. Accordingly, various modifications may be made without departing from the spirit or scope of the general inventive concept as defined by the appended claims and their equivalents.

What is claimed is:

1. A radio communication system for performing multicast communication comprising:
a reception ability value collector configured to collect a reception ability value of a mobile station belonging to a specific multicast group;
a transmission method determiner configured to determine a transmission method of transmitting information in accordance with the collected reception ability value;
a transmitter configured to transmit the information to the mobile station using the determined transmission method; and
a radio resource manager configured to manage available radio resources;
and wherein the transmission method determiner determines the transmission method in accordance with the reception ability value and the available radio resources, so that a mobile station equipped with a predetermined reception ability can receive the information using the determined transmission method.

2. A radio station comprising:
a reception ability value collector configured to collect a reception ability value of a mobile station belonging to a specific multicast group;
a transmission method determiner configured to determine a transmission method of transmitting information in accordance with the collected reception ability value; and
a transmitter configured to transmit the information to the mobile station using the determined transmission method;
and wherein the transmission method determiner determines the transmission method so that a mobile station equipped with the best reception ability can receive the information using the determined transmission method.

3. A radio station comprising:
a reception ability value collector configured to collect a reception ability value of a mobile station belonging to a specific multicast group;
a transmission method determiner configured to determine a transmission method of transmitting information in accordance with the collected reception ability value; and
a transmitter configured to transmit the information to the mobile station using the determined transmission method;
and wherein the transmission method determiner determines the transmission method so that a mobile station equipped with the worst reception ability can receive the information using the determined transmission method.

4. A radio station comprising:
a reception ability value collector configured to collect a reception ability value of a mobile station belonging to a specific multicast group;
a transmission method determiner configured to determine a transmission method of transmitting information in accordance with the collected reception ability value;
a transmitter configured to transmit the information to the mobile station using the determined transmission method; and
a radio resource manager configured to manage available radio resources;
and wherein the transmission method determiner determines the transmission method in accordance with the reception ability value and the available radio resources, so that a mobile station equipped with a predetermined reception ability can receive the information using the determined transmission method.

5. The radio station according to any one of claims 2 to 4, wherein the reception ability value is defined by at least one of a demodulation method, a reception buffer size, a computing processing ability, an error correction method and an interleaving length.

6. The radio station according to any one of claims 2 to 4, wherein the transmission method is determined by at least one of a modulation method, transmission power, a method of organizing the information hierarchically, the amount of data, the numbers of codes, an error correction method, the numbers of blocks, an interleaving length and a rate matching method.

7. The radio station according to any one of claims 2 to 4, wherein the radio resource is defined by at least one of transmission power, the numbers of codes, the numbers of frequencies and propagation conditions.
